(19) United States
(12) Patent Application Publication
(10) Pub. No.: US 2009/0093966 A1
(43) Pub. Date: Apr. 9, 2009

(54) Hybridization data processing method using probe array

(75) Inventors: Mie Ishii, Tokyo (JP); Tomohiro Suzuki, Sagamihara-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/434,160

(22) Filed: May 16, 2006

(30) Foreign Application Priority Data
May 17, 2005 (JP) 2005-144167

(51) Int. Cl. G06F 19/00

(52) U.S. Cl. 702/19

(57) ABSTRACT

A data processing method of reducing signals to numerical values and processing the numerical values are provided. The signals are obtained by using a probe array where probes of a plurality of kinds are immobilized on a solid phase as so many spots such that a plurality of spots of probes of one kind are arranged on the solid phase and causing the array to react with a target substance. The method comprises (1) a step of acquiring the signal from each spot as numerical data, and (2) a step of eliminating singular values from the numerical data obtained for the plurality of spots of probes of one kind and processing the remaining numerical data to determine representative numerical data.

### BACKGROUND OF THE INVENTION

1. Field of the Invention

This invention relates to an arrangement of a probe array that allows to analyze a target substance such as a gene contained in a sample and also to a data processing method that is useful for accurately analyzing the results of hybridization using such a probe array.

2. Related Background Art

As typified by the human genome project, genes of various types of organisms have been clarified. Association of genes with mechanisms of vital activities, diseases, constitutions, and other factors have successively been examined. As a result, it has been found out that by determining the presence or absence of a specific gene or its expression level (abundance), diseases can be characterized or classified in more detail and effective therapeutic methods therefor can be chosen.

Many methods for determining the presence or absence of a specific gene or its abundance contained in a sample have been proposed over a long period of time. Among them, a method that chooses a specific partial sequence of a target gene or nucleic acid and examines the presence or absence of the partial sequence or the amount in a sample is widely used to know the presence or abundance of such a gene because of its wide applicability. More specifically, this method comprises preparing a nucleic acid (probe) corresponding to a complementary strand of the chosen partial sequence and detecting hybridization between the sample and the probe by any means, so as to determine the presence or absence of the nucleic acid sequence in the sample.

Detection of a specific nucleic acid using hybridization can be carried out either in a solid phase or in a liquid phase. When hybridization is carried out on a solid substrate, a typical method is to immobilize or adsorb a probe on the solid substrate, and then add thereto a sample labeled with a certain labeling substance enabling detection, so that detection is carried out by measuring the signal of the labeling substance on the solid substrate. In particular, a representative form used in solid-phase hybridization is a chip in which one or more probes are immobilized or adsorbed on a planar substrate such as a glass or metal, or a bead carrying a probe immobilized on the surface of a fine particle. The reason why solid-phase hybridization is preferable is that B/F separation is easy, the detection region can physically be made very small whereby high sensitivity is expected, plural types of probes can be separated physically thereby enabling simultaneous detection of multi-items, and handling and application area easy because of the solid phase.

As disclosed in U.S. Pat. No. 6,410,229, for example, a labeled sample nucleic acid is reacted with oligo DNA synthesized on a planar substrate, and the hybridization is measured by fluorescence detection, so as to detect the presence or absence of a specific nucleic acid in a sample or the amount thereof. Japanese Patent Application Laid-Open No. 2001-128683 discloses preparation of a DNA array using a substrate provided with amino groups to detect a 22-mer single-stranded labeled DNA.

Meanwhile, with a method of detecting a specific nucleic acid by utilizing hybridization as mentioned above, it is a general practice to observe the signal of a labeling substance and numerically express the signal intensity. It is possible to read the DNA, or the gene, contained in the sample and the expressed quantity thereof on the basis of the numerically expressed signal intensity.

Japanese Patent Application Laid-Open No. 2003-121441 discloses a fluorescence signal processing method of preparing a micro-array where probes are provided with different concentrations for one species, detecting fluorescence signals of two different types and computing the ratio and the variance thereof to evaluate the outcome of an experiment.

### SUMMARY OF THE INVENTION

However, with a DNA micro-array, it should not be disregarded that the signal intensity obtained from an experiment does not necessarily correspond to the quantity of the DNA contained in the sample. For example, the quantities of the probes spotted on a DNA micro-array may not be uniform and the experiment may not be completed properly because air bubbles and/or impurities may have intruded into the micro-array at the time of hybridization.

In short, there has been a problem that the environment of experiment is reflected to the outcome of the experiment to damage the reproducibility and the reliability of the experiment.

In view of the above-identified problem, it is therefore the first object of the present invention to provide a probe array such as a DNA micro-array that can ensure reproducibility and provide reliable data regardless of the environment of experiment. As will be described in greater detail hereinafter, according to the present invention, this problem is dissolved by providing a probe array that gives a plurality of signal data for probes of one kind.

In this regard, when a plurality of signal data is obtained for probes of one kind, the technique to be used for totalizing them will be vital to the results of the experiment. A conceivable technique may be determining the average of the signal data. It may be safe to assume that the plurality of signal data relating to the probes of one kind that are subjected to hybridization on the same DNA micro-array generally shows substantially same signal values or a normal distribution. Nevertheless, as pointed out above, the signal values can be dispersed if air bubbles and/or impurities intrude into the micro-array. Moreover, there is an additional problem that fluorescence that is used as a detection means can fluctuate depending on the environment and can be affected at the time of detection by scattered light that is produced in a solid phase observation. Then, the values of the obtained signal data may be distorted from the normal distribution.

A conventional technique for securing accuracy of such experimental data may be manually eliminating the data that show singular values while viewing the fluorescent image. However, this technique is accompanied by a problem that, as the number of probe types and the number of experiments increase, the time spent for such a process of manual elimination of data showing singular values increases. Additionally, a manual operation while viewing an image may entail a problem of overlooking when the amount of data to be processed increases.

In view of the above-identified problem, it is therefore the second object of the present invention to provide a data processing method that can acquire reliable data and reduce the time required for data analysis.

In an attempt of achieving the above objects, the inventors of the present invention found out a technique for preparing a probe array where a plurality of spots of probes of one kind is immobilized on the same solid phase, causing the probes to react with a specimen and efficiently analyzing the obtained signal data.

In an aspect of the present invention, there is provided a data processing method of reducing signals to numerical values, the signals being obtained by using a probe array where probes of a plurality of kinds are immobilized on a solid phase as so many spots such that a plurality of spots of probes of one kind are arranged on the solid phase and causing the array to react with a target substance, and processing the numerical values, the method comprising:

(1) a step of acquiring the signal from each spot as numerical data; and

(2) a step of eliminating singular values from the numerical data obtained for the plurality of spots of probes of one kind and processing the remaining numerical data to determine representative numerical data.

In another aspect of the present invention, there is provided a data processing method of reducing signals to numerical values, the signals being obtained by using a probe array where probes of a plurality of kinds are immobilized on a solid phase as so many spots such that a plurality of spots of probes of one kind are arranged on the solid phase and causing the array to react with a target substance, and processing the numerical values, the method comprising:

(1) a step of acquiring the signal from each spot as numerical data; and

(2) a step of determining a median value of the numerical data obtained from the plurality of spots of probes of one kind and using the median value as representative numerical data.

Thus, according to the present invention, it is possible to acquire reproducible and reliable data regardless of the environment of experiment by proving a DNA micro-array adapted to obtain a plurality of signal data for probes of one kind.

Additionally, according to the present invention, it is possible to totalize data, automatically eliminating experimental errors due to intrusion of air bubbles and/or impurities at the time of hybridization, by means of a data processing method according to the invention. Thus, it is possible to acquire reliable data without spending time and labor for analysis.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic illustration of two primers and three probes for pUC118 EcoRI/BAP, where the arrows indicate the directions from 5′ to 3′ of the respective primers;

FIG. 2 is a schematic illustration of the design of a DNA micro-array according to the present invention;

FIG. 3 is a flowchart of an embodiment of data processing method according to the present invention; and

FIG. 4 is a flowchart of another embodiment of data processing method according to the present invention.

### DESCRIPTION OF THE PREFERRED EMBODIMENTS

Preferred embodiments of the present invention will now be described in detail in accordance with the accompanying drawings.

A probe array that can be used for the purpose of the present invention is formed by immobilizing probes of a plurality of species on a solid phase one by one to form so many spots. The solid phase may be selected from substrates of various materials such as glass and plastics that are being popularly used in this technical field. There are no specific limitations to the technique to be used for immobilizing probes for the purpose of the present invention so long as it is suitable for effectively acquiring signals, although the use of the ink-jet method is particularly preferable because it can control the quantity of each probe to be immobilized on a solid phase with ease and arrange spots highly densely. The plane profile of the spots formed on a solid phase is not subjected to any specific limitations so long as they can be recognized independently. For example, the spots may show a circular profile. The size of the spots and the density of arrangement of the spots on the solid phase may be selected appropriately according to the purpose of acquiring data. Anyway, spots are arranged highly densely in a probe array according to the present invention so that the probe array can be used as micro-array.

The plurality of spots of probes of one kind are arranged on a solid phase preferably without adjacently located with each other when they are arranged highly densely from the viewpoint of preventing signal reading errors from occurring. When probes of one kind are arranged so close as to cause signal reading errors to occur, it is preferable that a probe of a different type is always present on the line connecting two closely located probes of the single kind. Inversely stated, even when spots are arranged highly densely, it is possible to prevent signal reading errors from occurring by arranging a third probe of a different kind between two closely located probes of one kind.

In an area where probes are arranged, the spots of probes of one kind are preferably arranged uniformly and apart from each other. Then, expectedly it is possible to prevent reactions from taking place not uniformly due to air bubbles and raise the probability of contact with the target substance.

More specifically, a preferable arrangement of probe spots is such that the area for arranging probe spots is evenly divided into N sections and a predetermined number of spots (e.g., 1 spot) are arranged in each section.

According to the present invention, a plurality of spots of probes of one kind are formed on a solid phase. One probe solution or two or more probe solutions of the same kind of probes showing substantially the same probe concentration will be used for forming a plurality of spots of probes of one kind. Then, as a result, a plurality of spots of probes of one kind are formed to have a uniform quantity. The dispersion of concentration of probe solutions showing substantially the same probe concentration is typically held within a range of ±30%, preferably within a range of ±10%.

As pointed out above, the use of the ink-jet method is particularly preferable as means for uniformly immobilizing probes with a uniform quantity. With the ink-jet method, it is possible to uniformize the quantities of ejected liquid micro-droplets. Thus, it is possible to uniformize the quantities of probes in the spots formed on a solid phase by applying solutions of the same probe concentration to spot forming regions by the same quantity and hence the use of the ink-jet method is particularly preferable for forming spots of probes so as to be immobilized by the same quantity. Moreover, it is preferable to eject probe solutions from the same ejection port under the same ejecting conditions onto different positions on a substrate to form a plurality of spots.

According to the present invention, for each of a plurality (n) of different kinds of probes (P1 . . . Pn: n≧2), a plurality (N) of spots (P1S1 . . . PLSN; . . . ; PnS1 . . . PnSN) of probes of the same and uniform quantity are formed. Preferably, a number not smaller than 6 and not greater than 1,000 is selected for N in order to achieve reliability in data processing. More preferably, a number of not smaller than 9 and not greater than 100 is selected for N.

For instance, 16 spots (N=16) are formed for each of three kinds of probes P1 through P3 in the examples described later in greater detail.

With a data processing method according to the present invention, signals are detected from the N spots of probes of one kind as numerical values for the outcome of hybridization of the probe array and the target specimen (target substance) and the numerical data are totalized for the probes of one kind.

When processing the totalized numerical data, one of the processing techniques of (1) eliminating singular values from the obtained plurality of numerical data, totalizing the remaining data and using the totalized value as data showing the outcome of hybridization (formation of a hybrid body) and

(2) determining a median value of the obtained plurality of numerical data and using the median value as numerical data showing the outcome of hybridization, is used.

A method of eliminating singular values in the processing technique (1) that can suitably be used for the purpose of the present invention comprises a step of computing an average value of all the numerical data obtained for each probe and a step of computing a variance of all the numerical data obtained for each probe so as to eliminate singular values on the basis of the variance and the average value. A step of eliminating the data on the spot or spots that are found to be wrong in advance may be provided. Then, the outcome of any experiment may not be discarded as failure because of intrusion of impurities and/or air bubbles so that the precious experiment data can be utilized effectively to realize a highly precise data processing operation.

With such a data processing operation, it is possible to detect if the outcome of the experiment shows an abnormal distribution because, for example, the numerical values of the data set obtained as a result of hybridization are biased to opposite extremities or not. Then, it is possible to suggest if the experimenter has made a failure or not or if the probe array was made defective on the manufacturing line or not by issuing an error message.

The above-described data processing method is effective not only for the experimenter who tests and evaluates an unknown specimen but also for the manufacturer of the probe array who evaluates the quality of the own products. It is possible to eliminate adverse effects on the evaluation of quality due to one or more than one errors produced not in the manufacturing process but in the evaluation process by hybridizing a manufactured probe array and a standard specimen and processing the obtained data by means of the above-described data processing method.

The step of eliminating singular values may be repeated until no singular value is found by modifying, if necessary, the conditions for eliminating singular values. Then, it is possible to determine the presence or absence of the specimen that is detected by means of the spot-forming probes to be used for data processing on the basis of the average value or distribution of the numerical values contained in the data set obtained as a result of eliminating singular values. Additionally, it is possible to prevent any misjudgment from occurring due to singular values by providing a step of activating an alarm not to accept the outcome of examination when the rate of singular values in the data set obtained from a plurality of spots of probes of one kind exceeds a predetermined level. The provision of such a step is highly effective for examinations that require a highly accurate judgment such as a diagnostic judgment of disease or a judgment on identification of a species by means of DNA comparison.

Still additionally, it is also possible to make accurate judgment by using a median value as numerical data showing the outcome of hybridization as in the above-described step (2).

Now, the method of preparing a micro-array and the data processing method according to the present invention will be described in greater detail below by way of examples. Note, however, while the examples that are described below illustrate the best modes of carrying out the invention, they do not limit by any means the technological scope of the present invention.

### Example 1

### I. Preparation of Micro-Array

### (1) Design and Synthesis of Probe

Three types of probes having the sequences as described hereinafter were designed from the base sequence of the vector pUC118 EcoRI/BAP (total length: 3162 bp) available from TAKARA BIO INC. All the base sequence information on pUC118 EcoRI/BAP is provided by TAKARA BIO INC. and also available from a publicized database. The probes were designed sufficiently considering the sequence, the GC % and the melting temperature (Tm value) so that the designed partial base sequences can be specifically recognized. Table 1 below shows the designed base sequences of the probes and the designed Tm values.

TABLE 1

| | | Tm |
|---|---|---|
| denomination | base sequence | (° C.) |
| P1 | 5′ATGGTGCACTCTCAGTACAATCTGC3′ | 75.7 |
| P2 | 5′GTGGGTTACATCGAACTGGATCTCA3′ | 75.8 |
| P3 | 5′GATAAAGTTGCAGGAGCACTTCTGC3′ | 75.7 |

It should be noted that the probes were designed so that the DNA strand of pUC118 EcoRI/BAP extending from the R primer in the PCR amplification described later can be hybridized with those probes to form a hybrid body with the probes.

### (2) Washing of Glass Substrate

A synthetic quartz glass substrate (size (W×L×T): 25 mm×75 mm×1 mm: available from IIYAMA PRECISION GLASS CO., LTD.) was put into a heat-resistant and alkali-resistant rack and immersed in a washing liquid for ultrasonic washing prepared to show a predetermined concentration. After immersed for a night, the glass substrate was subjected to an ultrasonic washing treatment for 20 minutes. Thereafter, the glass substrate was taken out and lightly rinsed with pure water and then subjected to an ultrasonic washing treatment for 20 minutes in ultrapure water. Then, the glass substrate was immersed in a 1N aqueous solution of sodium hydroxide that was heated to 80° C. Thereafter, the glass substrate was once again subjected to an ultrasonic washing treatment using pure water and one using ultrapure water to prepare a washed quartz glass substrate for forming a DNA chip.

### (3) Surface Treatment

Silane coupling agent KBM-603 (available from Shin-Etsu Silicones) was dissolved in pure water to show a concentration of 1% and then the solution was agitated for 2 hours at room temperature. Subsequently, the washed quartz glass substrate was immersed in the silane coupling agent solution for 20 minutes at room temperature. Then, the glass substrate was pulled out and the surface thereof was lightly washed with pure water and dried by blowing nitrogen gas. Thereafter, the dried glass substrate was baked in an oven heated to 120° C. for 1 hour to complete the coupling process. As a result of the coupling process, amino groups that were derived from the silane coupling agent were introduced to the surface of the glass substrate.

Meanwhile, a solution of N-(6-maleimidocaproyloxy)succinimide (to be abbreviated as EMCS hereinafter) available from DOJINDO Laboratories was prepared by dissolving EMCS in an 1:1 mixed solvent of dimethylsulfoxide and ethanol so as to show a final concentration of 0.3 mg/ml. After baking, the coupling-agent-treated glass substrate was allowed to be cooled and then immersed in the prepared EMCS solution for 2 hours at room temperature. During the period of immersion, the amino groups introduced to the surface of the coupling-agent-treated glass substrate and the succinimide groups of the EMCS reacted with each other to introduce maleimide groups that were derived from the EMCS on the surface of the glass substrate. The glass substrate was then pulled out from the EMCS solution and washed with the mixed solvent of dimethylsulfoxide and ethanol and subsequently with ethanol. Thereafter, the glass substrate was dried in a nitrogen gas atmosphere.

### (4) Synthesis of DNA for Probe

The probes designed in (1) above were synthesized.

The synthesized probe DNAs were subjected to a process of thiol formation at the 5′ terminus by means of the conventional method in order for them to be able to bind to the glass substrate, to the surface of which maleimide groups had been introduced, by covalent bonds. Subsequently, the protecting groups that had been introduced in order to avoid side reactions in the DNA synthesis were removed and the probe DNAs were subjected to HPLC purification and deionization.

Each of the obtained probe DNAs was then dissolved in pure water and dispensed so as to make the final concentration equal to 10 μM (at the time of being dissolved in ink) and then lyophilized to remove moisture.

### (5) Ejection of Probe DNA by Means of BJ Printer and Binding to Substrate Surface

An aqueous solution containing glycerin by 7.5 wt %, thiodiglycol by 7.5 wt %, urea by 7.5 wt % and Acetylenol EH (tradename, available from Kawaken Fine Chemicals Co., Ltd.) by 1.0 wt % was prepared. Subsequently, each of the probe DNAs was dissolved in the above mixed solution so as to show a predetermined concentration (10 μM). Each of the obtained probe DNA solutions was filled into an ink tank of a bubble jet printer (BJF-850, available from Canon) and loaded on the printing head of the bubble jet printer.

The bubble jet printer had been modified to be adapted for ink-jet printing on a plane plate. The remodeled bubble jet printer can form spots of droplets of about 5 pl of DNA solution at a pitch of about 120 μm by inputting a printing pattern according to a predetermined file preparation method.

Subsequently, an operation of spotting the surface of the glass substrate with probe DNA solutions was conducted by means of the remodeled bubble jet printer. As shown in FIG. 2, sixteen blocks including block 1 through block 16 were defined on the DNA micro-array and three spots of three probe DNA solutions (P1 through P3) were formed on each block. More specifically, the ejection printing pattern was prepared in advance in such a way that 16 spots were to be formed by each probe DNA solution and an ink-jet printing operation was carried out according to the prepared ejection printing pattern. After confirming that the spots of the DNA solutions were formed to produce the designed pattern through a magnifier, the substrate was laid still in a moisturizing chamber for 30 minutes at room temperature to allow the maleimide groups on the surface of the glass substrate to react with the sulfanyl groups (—SH) at the 5′ terminus of the probe DNAs.

### (6) Washing

After the 30 minutes reaction process in the moisturizing chamber, unreacted probe DNAs that were remaining on the surfaces of the glass substrates were washed out with a 10 mM phosphate buffer solution (pH: 7.0) that contained 100 mM NaCl. Thus, the predetermined single-stranded probe DNAs were immobilized on each of the 16 blocks of the DNA chip to obtain DNA micro-array type DNA chips.

### Example 2

### II. PCR of pUC118 EcoRI/BAP

### (1) Primer Design

Primers of two different types having respective sequences, which will be described hereinafter, that can be hybridized with the probes immobilized on the DNA micro-arrays prepared in I (Example 1) were designed on the basis of the base sequence of the vector pUC118 EcoRI/BAP (total length 3162 bp) available from TAKARA BIO INC.

When designing the primers, the sequence, the GC %, and the melting temperature (Tm value) were sufficiently taken into consideration so that the desired partial base sequence in the pUC118 EcoRI/BAP might be specifically and efficiently amplified.

The designed two types of primers included one for the forward side (F) and the other for the reverse side (R). The PCR products of 1324 bp were amplified by using the pUC118 EcoRI/BAP as template and amplifying it by PCR with the combination of the F and R primers. Table 2 below shows the base sequences and the Tm values of the designed primers.

TABLE 2

| | | Tm |
|---|---|---|
| denomination | base sequence | (° C.) |
| F | 5′ TGATTTGGGTGATGGTTCACGTAG3′ | 60.9 |
| R | 5′ ATCAGCAATAAACCAGCCAGCG3′ | 61.5 |

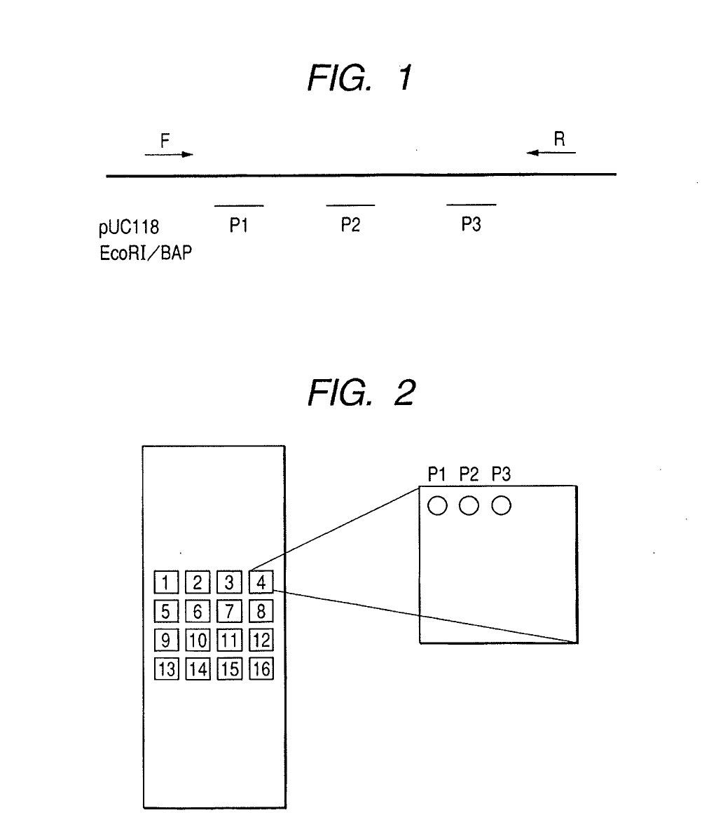

FIG. 1 shows the positions of the two types of primers in the total length of pUC118 EcoRI/BAP. In FIG. 1, the directions indicated by the arrows are those in which the primer strands are directed from the 5′ terminus toward the 3′ terminus.

### (2) Synthesis of Primers

Primers of the two types designed in (1) were synthesized. More specifically, DNA strands having the base-sequences of the respective primers were synthesized by means of the conventional method using a DNA synthesizer. Then, they were purified by cartridge purification to obtain the primers of the two types. The obtained primers were diluted to a concentration of 10 μM by a TE buffer.

### (3) PCR Amplification Reaction

The primers of the two types synthesized in (2), the vector pUC118 EcoRI/BAP available from TAKARA BIO INC. that was to be used as template DNA and a PCR kit HotStarTaq Master Mix available from QUIAGEN K.K. were used for a PCR amplification reaction. The Master Mix kit contained four deoxynucleotides of dATP, dCTP, dTTP and dGTP and Cy3dUTP available from GE Healthcare Bio-Sciences K.K. was added to label the PCR products by a fluorescence label. Thus, the PCR products were labeled by Cy3.

The forward and reverse primers were subjected to a PCR amplification process in combination as described in (1). The protocol shown below was used for the PCR reaction conditions and a reaction solution having the composition shown in Table 3 was prepared.

TABLE 3
Composition of Reaction Solution

| ingredients | contents | |
|---|---|---|
| Master Mix (Master Mix available | 25 | μl |
| from QIAGEN K.K.) | | |
| Template DNA (diluted pUC118: | 1 | μl (10 ng) |
| available from TAKARA BIO INC.) | | |
| Forward Primer (F1 or F2) | 2.5 | μl (25 pmol/tube) |
| Reverse Primer (R1) | 2.5 | μl (25 pmol/tube) |
| Cy3 dUTP (1 μM: available from GE | 2 | μl (25 pmol/tube) |
| Healthcare Bio-Sciences K.K.) | | |
| H₂O | 17 | μl |
| Total | 50 | μl |

A PCR amplification reaction was conducted for the prepared reaction solution by using a commercially available thermal cycler and according to the temperature cycle protocol shown in Table 4 below.

TABLE 4
Temperature Conditions for PCR Amplification Reaction

| | | | |
|---|---|---|---|
| | | retention | number of |
| step | temperature | time | cycles |

| | | | | |
|---|---|---|---|---|
| 1 | 95° C. | 15 | min. | |
| 2 | 92° C. (denaturation) | 45 | s | 25 cycles |
| 3 | 55° C. (annealing) | 45 | s | |
| 4 | 72° C. (extension) | 1 | min. | |
| 5 | 72° C. | 10 | min. | |

After the amplification reaction, the PCR-amplified product was purified by means of a purification column (QIAGEN QIAquickPCR Purification kit). After the purification, a PCR-amplified product solution was prepared to have a volume of 50 μl. A part of the purified PCR-amplified product solution thus obtained was then sampled and subjected to electrophoresis by using the conventional method to confirm that the PCR-amplified product showed a band having the desired base length.

### III. Hybridization Reaction

The DNA micro-array prepared in I (Example 1) and the PCR-amplified product prepared in II as a nucleic acid specimen were hybridized on the micro-array.

### (1) Blocking of DNA Micro-Array

BSA (bovine serum albumin Fraction V: available from Sigma-Aldrich Japan K.K.) was dissolved into a 100 mM NaCl/10 mM phosphate buffer solution and the DNA micro-array prepared in I (Example 1) was immersed in the solution at room temperature for 2 hours to block the surface of the glass substrate. After the blocking, the glass substrate was washed with a 0.1×SSC solution (NaCl: 15 mM, sodium citrate (trisodium citrate dehydrate, C₆H₅Na₃.2H₂O): 1.5 mM, pH: 7.0) that contained SDS (sodium dodecyl sulfate) by 0.1 wt % and then rinsed with pure water. Thereafter, the DNA micro-array was spin-dried by means of a spin-drying apparatus.

### (2) Preparation of Hybridization Solution

A hybridization solution was prepared to show a final concentration as shown below for each of the PCR products.

### <Hybridization Solution>

6×SSPE/10% formamide/PCR-amplified product solution

(6×SSPE: NaCl 900 mM, NaH₂PO₄.H₂O 60 mM, EDTA 6 mM, pH: 7.4)

### (3) Hybridization

The spin-dried DNA chip was set in a hybridization apparatus (Hybridization Station, available from Genomic Solutions Inc.) and a hybridization reaction was made to take place by using a hybridization solution showing the above composition, following the procedure shown in Table 5 below under the conditions also listed in Table 5.

TABLE 5
Hybridization Procedure and Conditions

| operation | procedure and conditions |
|---|---|
| reaction | 65° C., 3 min → 92° C., 2 min → 45° C., 4 h |
| washing | 2 × SSC/0.1% SDS at 25° C. |
| | 2 × SSC at 20° C. |
| (rinsing) | H₂O (manual rinsing/washing) |
| drying | spin drying |

### (4) Fluorescence Observation

After the end of the hybridizing reaction, the spin-dried DNA chip was observed for fluorescence from the hybrid bodies by means of a fluorescence detection apparatus for DNA micro-arrays (Genepix 4000B, available from Axon Instruments). Table 6 shows the results obtained by the observation of the intensity of fluorescence.

TABLE 6

| | P1 | P2 | P3 |
|---|---|---|---|
| 1 | 139.6 | 3455.9 | 10081.4 |
| 2 | 116.9 | 2864.9 | 7949.9 |
| 3 | 211.6 | 2520.9 | 7379.2 |
| 4 | 91.4 | 2049.8 | 5949.9 |
| 5 | 193.6 | 3268.2 | 9838.8 |
| 6 | 102.3 | 2861.7 | 8083.5 |
| 7 | 118.0 | 2345.4 | 7103.9 |
| 8 | 83.7 | 78.2 | 289.6 |
| 9 | 103.8 | 3222.3 | 10010.9 |
| 10 | 123.4 | 2437.1 | 7224.9 |
| 11 | 203.2 | 2595.2 | 7680.8 |
| 12 | 85.1 | 75.0 | 244.3 |
| 13 | 96.1 | 3292.2 | 9885.5 |
| 14 | 98.0 | 2642.2 | 7926.6 |
| 15 | 102.4 | 2559.8 | 7402.2 |
| 16 | 70.6 | 65.8 | 93.9 |

In Table 6, 1 through 16 correspond to the block numbers of the DNA chips illustrated in FIG. 2. Thus, a total of 16 observation data were obtained for each probe as a result of the fluorescence observation. The average values μ and the variance σ of the intensity data were determined for each probe. Table 7 below shows the determined values.

TABLE 7

| | P1 | P2 | P3 |
|---|---|---|---|
| μ | 121.2 | 2270.9 | 6696.6 |
| σ | 43.9 | 1155.1 | 3432.2 |
| 3σ/μ | 1.09 | 1.53 | 1.54 |

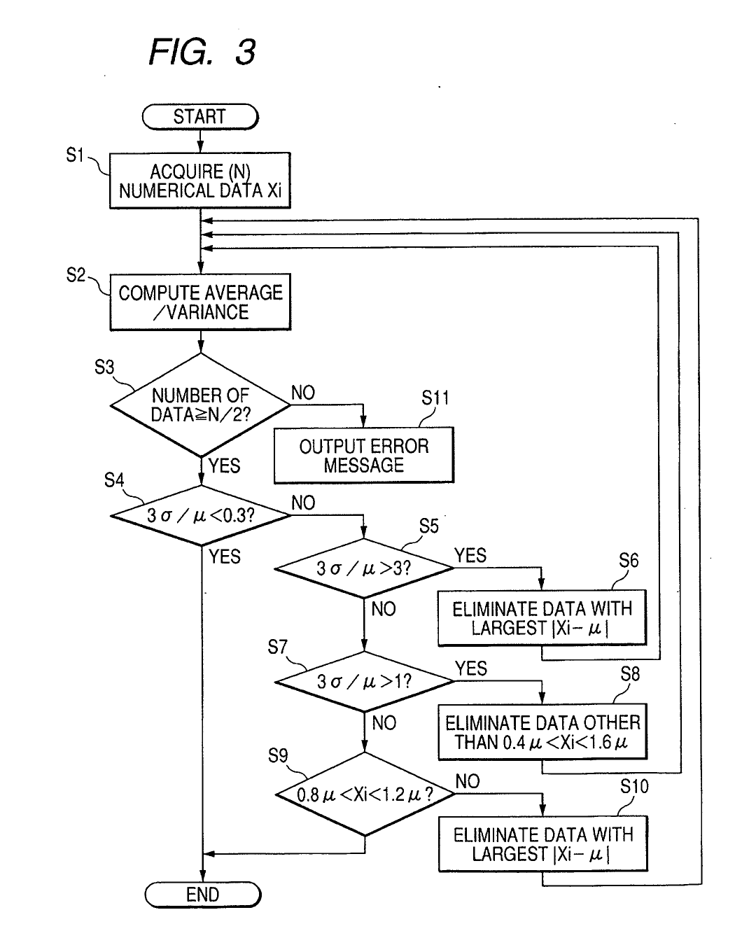

When data show a normal distribution, 99.7% of all the data are included between μ−3σ and μ+3σ. In other words, greater is the value of 3σ/μ, so is larger the dispersion of the data. The intensity data obtained from the DNA probes at different locations should ideally show the same value when the probes are of the same kind and of the same concentration. Then, even if they show dispersion to a slight extent, the relationship of 3σ/μ≦0.2 holds true. The value of 3σ/μ is large when singular data are involved because of air bubbles and impurities intruded at the time of hybridization. Therefore, singular data are eliminated by following the procedure illustrated in the flowchart of FIG. 3.

Referring to FIG. 3, firstly in Step 1(S1), the data Xi (the number of data is N) to be totalized are acquired. In the instance of the probe P3, 16 data are acquired as observation data. Subsequently, in Step 2(S2), the average value μ and the variance σ of the data acquired in S1 are computationally determined. In the case of the probe P3, μ=6696.6 and σ=3432.2 are obtained by computations. In Step 3(S3), the current number of data Xi is checked. Since no data is eliminated yet and the initial number of data N is 16 (N=16), the operation proceeds to Step 4(S4). Since 3σ/μ is 1.54 and larger than 0.3, the operation proceeds to Step 5(S5). Then, if 3σ/μ is larger than 3, the operation proceeds to Step 6. When 3σ/μ is larger than 3, the intensity values often include singularly large values due to impurities to distort the average value and the variance significantly. Therefore, the absolute value of the differences between the acquired data Xi and the average value μ is determined and the data that gives the largest absolute value is eliminated (S6). Then, the operation returns to S2, where the average value and the variance of the remaining data are determined anew.

Since 3σ/μ is smaller than 3 in the case of the probe P3, the operation proceeds to Step 7(S7). Since 3σ/μ is 1.54 and larger than 1, the operation then proceeds to Step 8. Since 0.4μ=2678.6 and 1.6μ=10714.5, each of the data that do not satisfy the inequality is eliminated (S8). Thus, the 8th data, 12th data and 16th data are eliminated.

Then, the operation returns to S2, where the average value and the variance of the remaining thirteen data are computed anew. Thus, μ=8193.7 and σ1332.0 are determined anew. Subsequently, the operation proceeds to S3. Then, since the number of data is 13 and larger than N/2=8, the operation proceeds to S4. Since 3σ/μ is equal to 0.49, the operation moves as S5→S7→S9. Since 0.8σ=6554.9 and 1.2μ=9832.4 and if there are one or more than one data that do not satisfy the inequality by referring to the above values, the operation proceeds to Step 10, where the data that shows the largest difference from the average value is eliminated (S10). In the above instance, the fourth data of 5949.9 shows the largest difference from the value of μ, or 2243.8, and hence it is eliminated.

Then, the operation returns to S2 once again to compute the average value and the variance of the remaining twelve data anew. As Steps S2 through-S9 are repeated, it becomes possible to obtain reliable data that satisfy the requirement of the inequality of S4 and show little dispersion when the number of data is equal to eight because of μ=7593.9, σ=367.2 and hence 3σ/μ=0.15. Thus, the processing operation ends.

If the number of the remaining data becomes less than N/2 as a result of repeating the above steps (S3), an error message is issued to prompt to review the data (S11).

If the value of 3σ/μ is larger than 0.3, the data processing operation ends when the remaining data satisfy the requirement of 0.8μ≦Xi≦1.2μ (S9).

As a result of the above processing operation, which is repeated for the other probes P1 and P2, it is possible to obtain data that show little dispersion as illustrated in Table 8 below.

TABLE 8

| | P1 | P2 | P3 |
|---|---|---|---|
| μ | 99.8 | 2782.7 | 7593.9 |
| σ | 11.6 | 344.3 | 367.2 |
| 3σ/μ | 0.35 | 0.37 | 0.15 |

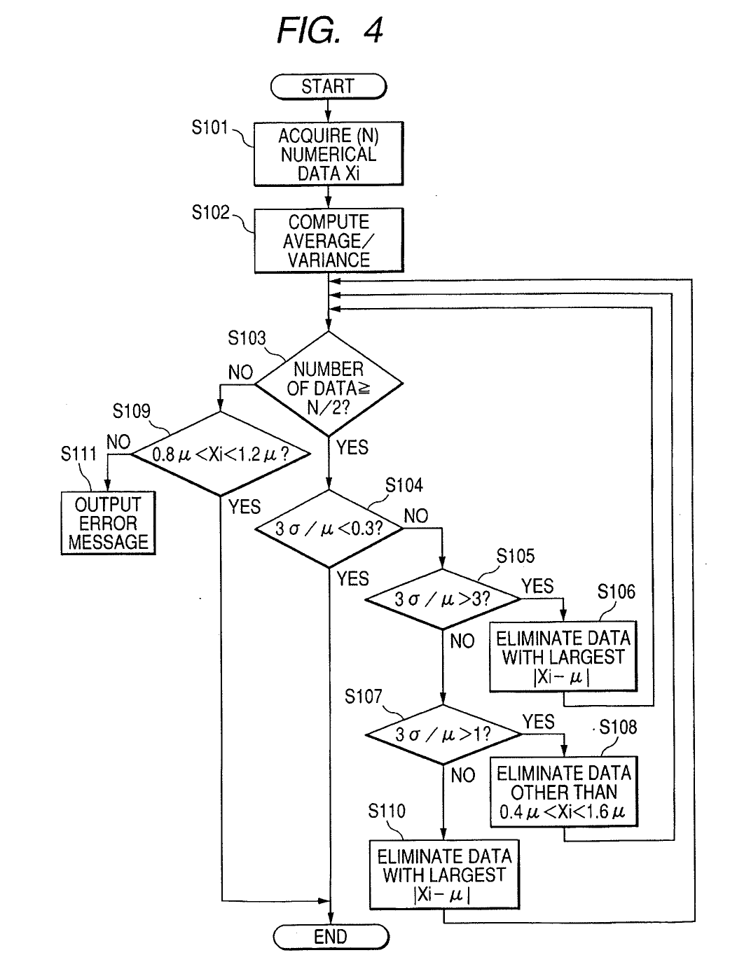

It is also possible to eliminate singular data by following the procedure of processing operation illustrated in the flowchart of FIG. 4. Now, the procedure of processing operation of FIG. 4 will be described by using the data of probe P2 shown in Table 6 as example.

Firstly, in Step 1(S101), the data Xi (the number of data is N) to be totalized are acquired. In the instance of the probe P2, 16 data are acquired as observation data. Subsequently, in Step 2(S102), the average value μ and the variance σ of the data acquired in S101 are computationally determined. In the case of the probe P2, μ=2270.9 and σ1155.1 are obtained by computations. In Step 3(S103), the current number of data Xi is checked. Since no data is eliminated yet and the initial number of data N is 16 (N=16), the operation proceeds to Step 4(S104). Since 3σ/μ is 1.53 and larger than 0.3, the operation proceeds to Step 5(S105). Then, if 3σ/μ is larger than 3, the operation proceeds to Step 6. When 3σ/μ is larger than 3, the intensity values often include singularly large values due to impurities to distort the average value and the variance significantly. Therefore, the absolute value of the differences between the acquired data Xi and the average value μ is determined and the data that gives the largest absolute value is eliminated (S106). Then, the operation returns to S102, where the average value and the variance of the remaining data are determined anew.

Since 3σ/μ is smaller than 3 in the case of the probe P2, the operation proceeds to Step 7(S107). Since 3σ/μ is 1.53 and larger than 1, the operation then proceeds to Step B. Since 0.4μ=908.4 and 1.6μ=3633.5, each of the data that do not satisfy the inequality is eliminated (S108). Thus, the 8th data, 12th data and 16th data are eliminated.

Then, the operation returns to S102, where the average value and the variance of the remaining thirteen data are computed anew. Thus, μ=2778.1 and σ=425.8 are determined anew. Subsequently, the operation proceeds to S103. Then, since the number of data is 13 and larger than N/2=8, the operation proceeds to S104. Since 3σ/μ is equal to 0.46, the operation moves as S105→S107→S110. The difference between the value of each of the data and the average value is determined and the data that shows the largest difference from the average value is eliminated (S110). In the above instance, the fourth data of 2049.8 shows the largest difference from the value of μ, or 728.3, and hence it is eliminated.

Then, the operation returns to S102 once again to compute the average value and the variance of the remaining twelve data anew. As Steps S102 through S110 are repeated, it becomes possible to obtain reliable data that satisfy the requirement of the inequality of S4 and show little dispersion when the number of data is equal to eight because of μ=2603.4, σ=185.0 and hence 3σ/μ=0.21. Thus, the processing operation ends.

If the number of the remaining data becomes less than N/2 as a result of repeating the above steps (S103), the processing operation proceeds to S109. If 3σ/μ is larger than 0.3, the data processing operation is terminated when the remaining data satisfy the requirement of 0.8μ≦Xi≦1.2μ (S109→END). However, if the remaining data do not satisfy the requirement of 0.8μ≦Xi≦1.2μ, the operation proceeds to S111, where an error message is issued to prompt to review the data.

As a result of the above processing operation, which is repeated for the other probes P1 and P3, it is possible to obtain data as illustrated in Table 9 below.

TABLE 9

| | P1 | P2 | P3 |
|---|---|---|---|
| μ | 95.4 | 2603.4 | 7593.9 |
| σ | 7.9 | 185.0 | 367.2 |
| 3σ/μ | 0.25 | 0.21 | 0.15 |

Note that the threshold values of the steps where such threshold values are used can be defined according to the target detection accuracy. For example, the definition of “3σ/μ<0.3” in S4 is aimed to contain the data to be employed within the range of the average value μ±15%. This definition means that all the data sets are found within the range of the average value μ±30%. If the data of the data sets show a normal distribution pattern, about 90% of all the data are found within the range of the average value μ±1.8σ. However, in the case where the number of data of the data set obtained per probe by using micro-arrays is about ten, all the data are substantially found within the range of the average value μ±1.8σ if the data of the data set satisfies the above definition. In other words, the data to be processed are found within the range of the average value μ±15%. If the data to be obtained do not require such a level of rigorousness of quantification, a less rigorous definition may be used and the threshold value of S4 may be defined such as “3σ/μ<0.3” for instance.

The numerical data (e.g., the value of μ) obtained by eliminating singular values by the above processing operation may then be compared with a numerical value selected in advance to show negativeness or positiveness to determine if the target nucleic acid that can be detected by the probes existed in the specimen or not. It is also possible to compare the data showing the variance obtained by eliminating singular values with a predefined reference value for showing negativeness or positiveness to determine the allowable range for data that show positiveness.

### Example 3

Hybridization information is input before carrying out the data processing operation as described in Example 2.

This will be described by referring to the outcome of the experiment of Example 2. In this experiment, it was found that the hybridization solution had not permeated the entire DNA micro-arrays at the time of hybridization and air bubbles had been found at the right side. Thus, it is input that the data of the blocks 8, 12 and 16 are error data before the totalizing operation.

Subsequently, the data processing sequence of FIG. 3 is followed. When acquiring numerical data Xi in S1, the data of the blocks that are proved to be errors are not acquired. With this arrangement, the initial number of data is equal to N=13. As obvious error data are eliminated in advance, the number of times of following the loop of steps for eliminating dispersion of data is reduced in the data processing operation to make it possible to process data efficiently. Additionally, if an accident occurs to partly destroy the DNA micro-arrays and data are obtained only from a half of all the blocks, it is possible to reliably totalize the obtained data.

### Example 4

There can be occasions where all the data are eliminated or 3 σ/μ shows a large value although there is no data to be eliminated as a result of a data processing operation as described above in Example 2. Then, the processing operation of this example proceeds to a step for determining if the data set is a singular data set or not.

In this step, the obtained N data are arranged in the descending order of the signal values and the upper order N/2 data and the lower order N/2 data are processed separately by following the data processing procedure of FIG. 3. Then, the obtained average values and the variances are compared and, if the difference between the average value of the upper order data and that of the lower order data is not less than the variance, the data sets are biased to opposite extremities so that an error message is output to tell that the data set is a singular data set.

With the above-described process for determining the existence or nonexistence of a singular data set, it is possible to reduce the probability of outputting lowly reliable data. Additionally, it is also possible to suggest the possibility of error in the process of manufacturing DNA micro-arrays.

### Example 5

The median values of the numerical data of the spots of the probes illustrated in Table 6 are P1=103.1, P2=2577.5 and P3=7541.5. These values are substantially equal to the numerical values (Table 8) obtained by the data processing operation of Example 2. This fact suggests that it is possible to obtain reliable data that are not affected by hybridization errors by determining the median values.

To further improve the reliability of the process of this example, a process of determining if data are biased to opposite extremities or not as described above in Example 4 may be added.

The present invention is not limited to the above embodiments and various changes and modifications can be made within the spirit and scope of the present invention. Therefore to apprise the public of the scope of the present invention, the following claims are made.

This application claims priority from Japanese Patent Application No. 2005-144167 filed May 17, 2005, which is hereby incorporated by reference herein.

What is claimed is:

1. A data processing method of reducing signals to numerical values, said signals being obtained by using a probe array where probes of a plurality of kinds are immobilized on a solid phase as so many spots such that a plurality of spots of probes of one kind are arranged on the solid phase and causing the array to react with a target substance, and processing the numerical values, said method comprising:
(1) a step of acquiring the signal from each spot as numerical data; and
(2) a step of eliminating singular values from the numerical data obtained for the plurality of spots of probes of one kind and processing the remaining numerical data to determine representative numerical data.

2. The method according to claim 1, wherein the number of the spots of probes of one kind arranged on the solid phase is not less than 6 and not more than 1,000.

3. The method according to claim 1, wherein
the plurality of spots of probes of one kind are arranged at respective positions that are not adjacent relative to each other.

4. The method according to claim 1, further comprising:
a step of computing an average value of the numerical data; and
a step of computing a variance of the numerical data obtained for the plurality of spots of probes of one kind;
wherein singular values are eliminated based on the variance and the average value.

5. The method according to claim 1, further comprising:
a step of inputting information on an error or errors in a hybridization reaction.

6. The method according to claim 1, further comprising:
a step of outputting an error message when a set of numerical values obtained from the plurality of spots of probes of one kind includes singular values to a rate equal to or higher than a predetermined level.

7. A data processing method of reducing signals to numerical values, said signals being obtained by using a probe array where probes of a plurality of kinds are immobilized on a solid phase as so many spots such that a plurality of spots of probes of one kind are arranged on the solid phase and causing the array to react with a target substance, and processing the numerical values, said method comprising:
(1) a step of acquiring the signal from each spot as numerical data; and
(2) a step of determining a median value of the numerical data obtained from the plurality of spots of probes of one kind and using the median value as representative numerical data.

8. The method according to claim 7, wherein the number of the spots of probes of one kind arranged on the solid phase is not less than 6 and not more than 1,000.

9. The method according to claim 7, wherein the plurality of spots of probes of one kind are arranged at respective positions that are not adjacent relative to each other.


SEQUENCE LISTING (5 sequences)

SEQ ID NO: 1 - DNA, 25 bp, Artificial Sequence
  Probe
atggtgcactctcagtacaatctgc

SEQ ID NO: 2 - DNA, 25 bp, Artificial Sequence
  Probe
gtgggttacatcgaactggatctca

SEQ ID NO: 3 - DNA, 25 bp, Artificial Sequence
  Probe
gataaagttgcaggaccacttctgc

SEQ ID NO: 4 - DNA, 24 bp, Artificial Sequence
  Primer
tgatttgggtgatggttcacgtag

SEQ ID NO: 5 - DNA, 22 bp, Artificial Sequence
  Primer
atcagcaataaaccagccagcc